(19) United States
(12) Patent Application Publication
(10) Pub. No.: US 2026/0330913 A1
(43) Pub. Date: Oct. 22, 2026

(54) HYBRID DISPENSE RECYCLE MODULE

(71) Applicant: Cardtronics USA, Inc., Atlanta, GA (US)

(72) Inventor: Christopher William Wylie, Dundee (GB)

(21) Appl. No.: 19/180,373

(22) Filed: Apr. 16, 2025

(51) Int. Cl. G07D 11/18; G07D 7/181; G07D 11/25; G07D 11/34; G07D 11/50

(52) U.S. Cl. CPC G07D 11/18; G07D 7/181; G07D 11/25; G07D 11/34; G07D 11/50; G07D 2207/00; G07D 2211/00

(57) ABSTRACT

A hybrid cash dispense recycle module for automated teller machines (ATMs) combines high-capacity dispense-only cassettes with low-capacity, short-term containment escrows for recycling deposited cash. The module includes three dispenser cassettes with capacity of approximately 2,500 notes each for a total of 7,500 cash items, four recycling escrows for deposited cash with capacity of approximately 200 notes each for a total of approximately 800 recyclable items, and an overflow deposit stacking bin. Deposited notes are temporarily held in escrows until dispensed or moved to the deposit bin after a predetermined time. This hybrid approach improves efficiency and reliability by keeping the technologies for dispensing and depositing cash separate, reducing maintenance requirements and extending time between cash replenishment cycles.

### BACKGROUND

Automated teller machines (ATMs) and self-service terminals (SSTs) face operational challenges in managing cash dispensing and depositing functions. There is approximately 4-5 times the number of cash items dispensed versus deposited, requiring ATM operators to regularly replenish cash stocks since the supply of deposited cash does not meet the demand for dispensed cash. Additionally, deposited items are notoriously difficult to transport and position neatly into stacking bins in a manner that would facilitate their later retrieval and presentable dispensing to another customer, creating reliability and performance challenges for ATM operators.

### BRIEF DESCRIPTION OF THE DRAWINGS

FIG. 1 is a diagram illustrating a hybrid dispense recycle module, according to an example embodiment.

FIG. 2 is a diagram of a system for operating a hybrid dispense recycle module, according to an example embodiment.

FIG. 3 is a diagram of a flow diagram of a method for operating a hybrid dispense recycle module, according to an example embodiment.

### DETAILED DESCRIPTION

Self-service terminals (SSTs) and automated teller machines (ATMs) face critical operational challenges in balancing cash management functions. The significant disparity between dispensing and depositing activities—with dispensing occurring approximately 4-5 times more frequently than depositing—creates a fundamental imbalance in cash flow management. This disproportion necessitates frequent cash replenishment cycles, as the incoming deposited cash cannot satisfy the outgoing dispensing demands, resulting in increased operational costs and service frequency requirements.

Traditional cash handling systems struggle with the inherent difficulties of processing deposited items. Cash deposited by customers arrives in varying conditions and orientations, making it technically challenging to process these items into a uniform state suitable for subsequent dispensing. Conventional recycling systems that attempt to use the same cassettes for both functions face reliability issues due to the mechanical complexity required to perform both operations effectively.

The dual-function cassettes in traditional recycling modules incorporate additional mechanical components to accommodate both deposit and dispense operations. This increased complexity makes these components more susceptible to mechanical failures, jams, and breakdowns, leading to higher maintenance requirements, reduced operational uptime, and diminished customer satisfaction. Furthermore, these systems must overcome the technical hurdle of organizing randomly inserted deposited cash into a configuration that allows for reliable dispensing to subsequent customers.

In an embodiment, a hybrid cash recycling approach combines high-capacity dispense-only cassettes with low-capacity, short-term containment escrows for recycling deposited cash. This approach provides 3-4 dispenser cassettes of approximately 2,500 notes each for a total of approximately 7,500-10,000 cash items, to be replenished by branch staff or cash-in-transit (CIT) services.

In an embodiment, the hybrid dispense recycle module includes 4 recycling escrows for deposited cash, each with a capacity of approximately 200 notes for a total of 800 cash items that can be recycled as required during dispense requests. These escrows are positioned above the dispense-only cassettes and are configured based on the needs and usage patterns of the ATM/SST at its location, with each escrow associated with a specific denomination of cash items, which can include multiple escrows assigned to a same denomination for high-volume cash notes.

In an embodiment, each of the 4 recycling escrows is associated with a specific denomination based on observed traffic and needs of the location where the ATM/SST is deployed. The denomination designations are configurable and can include two or more escrows associated with the same denomination for high-volume notes. For example, two escrows might be associated with $20 bills, one escrow with $10 bills, and one escrow with $50 bills. This flexible configuration allows the system to be optimized for the specific cash handling patterns at each location. The dispense-only cassettes can also be associated with specific note denominations, which may or may not overlap with the denominations assigned to the recycling escrows.

In an embodiment, deposited notes first travel along an upper transport path upon entry into a bill infeed module. An existing validation escrow holds all notes associated with a deposit transaction until confirmation is received from a bill validator regarding the authenticity of each note. Once validated, genuine notes are moved out of the validation escrow and placed in one of the 4 additional escrows if the denomination of the note corresponds to one of the escrows that has space to include the note. If no space exists on any of the 4 escrows for the deposited note, or if the denomination does not match any of the pre-set denominations of the escrows, the note is put into an overflow bin which serves as a single deposit cassette. Non-genuine notes are handled differently: counterfeit bills are retained in a retract bin and not returned to the customer, while damaged bills are placed in a purge bin so the operator of the ATM/SST can subsequently receive replacement bills for the damaged bills. Bills that are incorrectly designated by the customer or are not valid currency are ejected back to the customer during the deposit transaction.

In an embodiment, during a dispense operation, the notes required are first pulled from the recycling escrows. If the escrows lack the needed notes, they are pulled from the dispense-only cassettes. This prioritization helps extend the time between cash replenishment cycles by utilizing deposited cash before accessing the main cash supply in the dispense cassettes.

The hybrid approach using small escrows instead of a conventional recycler module offers several significant benefits. First, it keeps the finely tuned technologies specific to dispensing cash-in-transit (CIT)/branch replenished cash separate from those best suited to the random nature of cardholder-fed, deposited cash items. This separation retains the high performance value of each function without burdening the other with unnecessary complexity.

Escrows are well established and rarely fail, so by replacing more complex cassettes associated with both dispensing and depositing with a combination of escrows and dedicated cassettes, the dispense and deposit operations become more reliable with fewer jams and reduced maintenance requirements. The mechanical design reduces points of failure, as the dispense-only cassettes do not need the additional components required to capture deposited cash.

Because most transactions at ATMs/SSTs are dispense operations, this arrangement and function reduce cash-in-transit (CIT) service calls required to replenish the cassettes. More likely, the CIT services are needed mostly to remove the dedicated deposit-only cassette when it becomes full, further optimizing operational costs.

The hybrid module effectively provides a recycler media depository without requiring a dedicated recycler module by adding the 4 extra escrows. These escrows are situated below the lower transport path and above the dispense-only cassettes, with the exact positioning depending on the cassette arrangement. When the dispense-only cassettes are horizontally stacked, the escrows sit above the topmost stacked cassette. When the dispense-only cassettes are vertically situated next to one another, the escrows sit above multiple or all of the dispense-only cassettes. This approach transforms a standard media depository into a recycling system without the cost and complexity of a full recycler module. By eliminating the need for a conventional recycle module with its complex dual-function cassettes, the system achieves greater reliability and efficiency. The hybrid module provides a low-cost recycler with a sweet-spot capacity required to keep a unit running during replenishment cycles, striking an optimal balance between recycling capability and system reliability.

In an embodiment, firmware on a printed circuit board (PCB) of the media depository maintains metrics of deposited and dispensed notes, including denominations and positions within the 4 extra escrows and the dispense-only cassettes. This enables efficient management of cash resources and helps optimize the configuration of escrows based on usage patterns.

In an embodiment, the firmware on the PCB also handles reconciliation and auditing functions by maintaining accurate counts of bills in each location. This enables the system to track the movement of cash items throughout the module, ensuring accurate accounting of all deposited and dispensed notes. The firmware's tracking capabilities allow for efficient cash management and simplified end-of-day reconciliation processes.

In an embodiment, the hybrid dispense recycle module utilizes existing security features to validate deposited cash items. A bill validator module validates each deposited bill to determine if it is genuine, damaged, or counterfeit. The system does not introduce new security features but leverages established validation technology to ensure that only genuine bills enter the recycling process. This validation occurs while the deposited notes are held in the validation escrow before they are routed to either the recycling escrows or the overflow bin. The security validation process helps maintain the integrity of the cash recycling system by preventing counterfeit or unfit notes from being dispensed to subsequent customers.

As used herein, a “transaction terminal,” a “media terminal,” a “media transaction terminal,” and/or “terminal” refers to a standalone composite device operated to perform transactions for or by consumers. A terminal can include an ATM, an SST, or a point-of-sale (POS) terminal. An SST can include a self-checkout terminal or a kiosk. The terminal includes a variety of peripheral devices, one of which is a media handling device or a media depository. The phrases “media handling device” and/or “media depository” may be used synonymously and interchangeably herein. The media depository handles deposited cash and checks and dispensed cash during a transaction at the terminal.

Embodiments presented herein enhance a conventional media depository with additional escrow modules and other modules to functionally create a more efficient media recycling device compared to conventional media recycling devices. This approach provides significant improvements in reliability and efficiency by separating the specialized technologies for dispensing and depositing while still enabling cash recycling functionality.

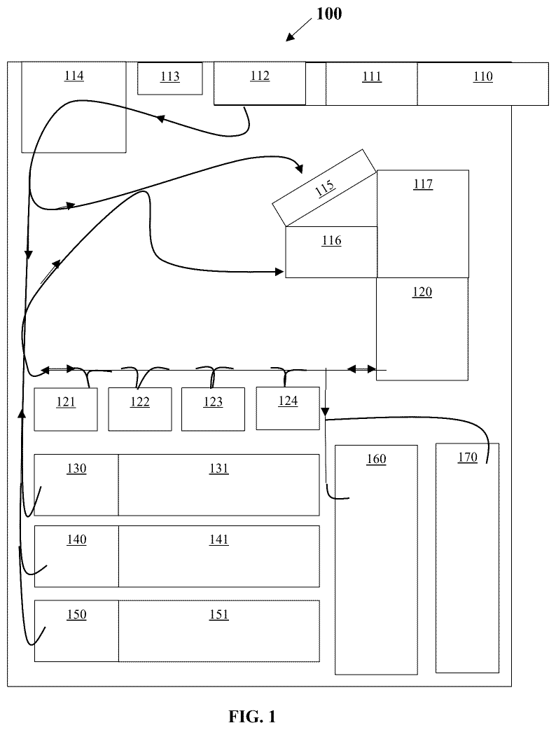

FIG. 1 is a diagram illustrating a hybrid dispense recycle module 100, according to an example embodiment. Notably, the components are shown schematically in simplified form, with only those components relevant to understanding of the embodiments being illustrated.

Furthermore, the various components are illustrated and the arrangement of the components are presented for purposes of illustration only. Notably, other arrangements with more or less components are possible without departing from the teachings of operating a hybrid dispense recycle module, presented herein and below.

The hybrid dispense recycle module 100 is an enhanced depository that fully functions as and is configured to operate as a media recycling device even though the hybrid dispense recycle module 100 lacks a conventional recycling device or module. The hybrid dispense recycle module 100 is a media peripheral device of a transaction terminal and handles valuable media (e.g., cash, checks, tickets, tokens, etc.) during cash-based or media-based transaction at the terminal.

The hybrid dispense recycle module 100 includes a media infeed module 110, a dispense carriage module 111, a deposit carriage module 112, a media de-bundler or media stripper module 113, a bill or note validator module 114, a media stacking tray 115, a media divert bin 116, a purge bin 117, a primary media escrow module 120, a first extended escrow module 121, a second extended escrow module 122, a third extended escrow module 123, a fourth extended escrow module 124, first pick module 130 for a first dispense media cassette 131, a second pick module 140 for a second dispense media cassette 141, a third pick module 150 for a third dispense media cassette 151, a stacking media deposit bin 160, and a retract media bin 170.

The media infeed module 110 may also be a media outfeed module such that deposited and dispensed media are processed through a same or close located exit location in a fascia of the housing for the hybrid dispense recycle module 100. The dispense carriage module 111 is responsible for holding dispensed cash items before being ejected through a media outfeed module to a customer during a dispense operation. The deposit carriage module 112 is responsible for holding and passing deposited cash items to the bill validator module 114. The stripper module 113 is responsible to separating a bunch of deposited cash items into individual cash items passed to the bill validator module 114. The bill validator module 114 validates whether cash items are genuine (e.g., legitimate), counterfeit, or damaged and unfit for further circulation during deposit operations.

During a cash item deposit operation, the primary media escrow module 120 receives each deposited cash item during the deposit operation. The deposited cash items are stored within a taped-based cylinder of the primary media escrow module 120 until all deposited cash items for a deposit operation are processed through the bill validator module 114. Each deposited cash item on the cylinder is associated with its position or location within the cylinder and associated with determinations made by the bill validator module 114. The determinations include a denomination for each cash item and at least one flag indicating whether a particular cash item is genuine, counterfeit, or damaged.

Once the primary escrow module 120 has all the deposited cash items and metadata associated with each cash item as to its position, denomination, and fitness (e.g., genuine, counterfeit, or damaged), each of the deposited cash items are moved according to their determinations to one of the purge bin 117, the stacking deposit bin 160, or the retract bin 170. Cash items that are being sent back to the customer during the deposit operation since they are unable to be accepted due to their associated determinations are sent from the primary escrow module 120 where they will be ejected back to the customer.

Cash items that are acceptable for the deposit operation are moved along the lower transport path into either one of the enhanced escrow modules 121-124 or the stacking deposit bin 160. Each enhanced escrow module (121-124) is associated with a specific cash denomination. For example, if a deposited cash item is a $20 bill and enhanced escrow module 122 is associated with a $20 denomination, the deposited cash item is moved along the lower transport path and stored in enhanced escrow module 122. This assumes that enhanced escrow 122 is not at capacity for storing cash items, when enhanced escrow module 122 is at storage capacity and no other enhanced escrow module 122 is associated with the $20 denomination, then the deposited $20 bill is moved out of primary escrow module 120 onto the lower transport path and into the stacking deposit bin 160.

Cash items that are counterfeit or damaged for the deposit operation are moved out of the primary escrow module 120 along the lower transport path into the retract bin 170. This allows recovery of these items for inspection for purposes of investigating counterfeit items and redeeming damaged items for new cash items with federal banking authorities permitting the damaged items to be removed from circulation and destroyed.

The hybrid dispense recycle module 100 includes an upper transport module and a lower transport module. The upper transport module moves media items along an upper transport path between modules 111-120. The lower transport module moves media items along a lower transport path between modules 121-170.

During a cash dispense operation, any needed cash item, based on its denomination, is first attempted to be obtained from one of the enhanced escrow modules 121-124. If there is no enhanced escrow module 121-124 that can provide a cash item in the required denomination, then the needed denomination is obtained directly from one of the media dispense cassettes 131, 141, or 151 using the corresponding pick modules 130, 140, or 150.

In an embodiment, instead of the 4 enhanced escrow modules 121-124 as illustrated in FIG. 1, there are just 3 enhanced escrow modules. In an embodiment, the cash denominations associated with the enhanced escrow modules 121-124 are configured based on historical cash dispense patterns associated the hybrid dispense recycle module 100. For example, a physical location of the hybrid dispense recycle module 100 may be located in a casino where a high volume of high denominations are frequently withdrawn for cash dispense operations. In this case, two of the enhanced escrow modules may be associated with a $100 denomination, 1 associated with a $20, and 1 associated with $10. That is, at least two of the enhanced escrow modules 121-124 may be associated with a same denomination.

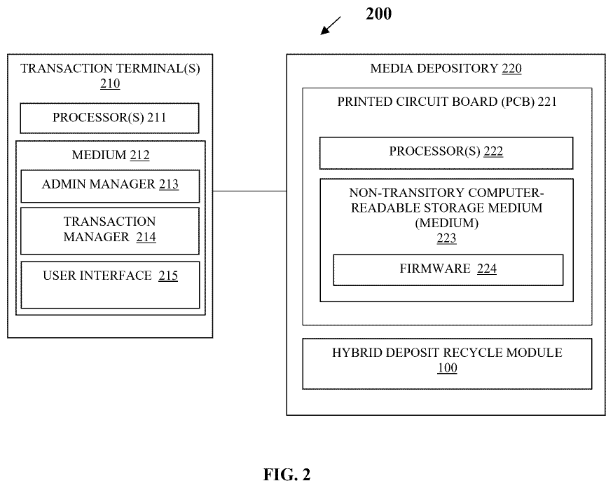

FIG. 2 is a diagram of a system 200 for operating a hybrid dispense recycle module, according to an example embodiment. Notably, the components are shown schematically in simplified form, with only those components relevant to understanding of the embodiments being illustrated.

Furthermore, the various components are illustrated and the arrangement of the components are presented for purposes of illustration only. Notably, other arrangements with more or less components are possible without departing from the teachings of operating a transaction terminal or system 200 with a hybrid dispense recycle module, presented herein and below.

The system 200 includes a transaction terminal 210 and a media depository 220. The transaction terminal 210 includes at least one processor 211 and a non-transitory computer-readable storage medium (medium), which includes instructions for an administrative manager 213, a transaction manager 214, and a user interface 215. The instructions when executed by the processor 211 cause the processor to perform operations discussed below with respect to 213-214.

The transaction manager 214 is configured to perform transactions of a customer such as media deposit operations and media dispense operations. In an embodiment, the customer performs a transaction to purchase an item and provides cash as payment for the transaction. In an embodiment, the customer performs a transaction to deposit money via cash items, checks, or a combination of cash items and checks. In an embodiment, the customer performs a transaction to withdraw cash items. The customer interacts with user interface 215 during the transaction. Transaction manager 214 controls the user interface states and screens during the transaction.

The admin manager 213 permits a user with appropriate credentials to access administrative operations of terminal 210 and depository 220. The user performs the operations via interactions with user interface 215. The administrative manager 213 controls the user interface states and screens during an administrative session with the user.

Media depository 220 includes a PCB 221 and the hybrid deposit recycle module 100. The PCB 221 includes at least one processor 222, medium 223, which includes firmware instructions 224. The firmware 224 when executed by the processor 222 cause the processor to maintain metrics (e.g., media counts, denomination counts, denomination positions within modules of the hybrid deposit recycle module 100, flags associated with media items within the modules, media item storage capacities of the modules, etc.) and metadata for deposited media items and dispensed media items. The firmware 224 also controls the upper transport path, the lower transport path, and the modules of the hybrid deposit recycle module 100 during media deposits and media withdrawals.

In an embodiment, the firmware on the PCB 221 is configured to move deposited cash items from the enhanced escrow modules 121-124 to the stacking deposit bin 160 after a predetermined time period if the cash items have not been dispensed. This helps ensure that cash items do not remain in the escrows indefinitely and maintains optimal operation of the recycling function.

Notably, media depository 220 lacks a recycle module. Rather, hybrid deposit recycle module 100 includes 3 to 4 of the enhanced media escrow modules 121-124 within the hybrid deposit recycle module 100. That is, a conventional media depository is retrofitted and enhanced with firmware 224 and enhanced escrow modules 121-124 to operate as a media recycling device, which is a peripheral device of transaction terminal 210 during media-based transactions at terminal 210.

The hybrid deposit recycle module 100 effectively transforms a conventional media depository into a recycling system without requiring a dedicated recycler module. This is achieved by strategically positioning the enhanced escrow modules 121-124 between the transport paths and the dispense cassettes, creating a more efficient and reliable cash handling solution.

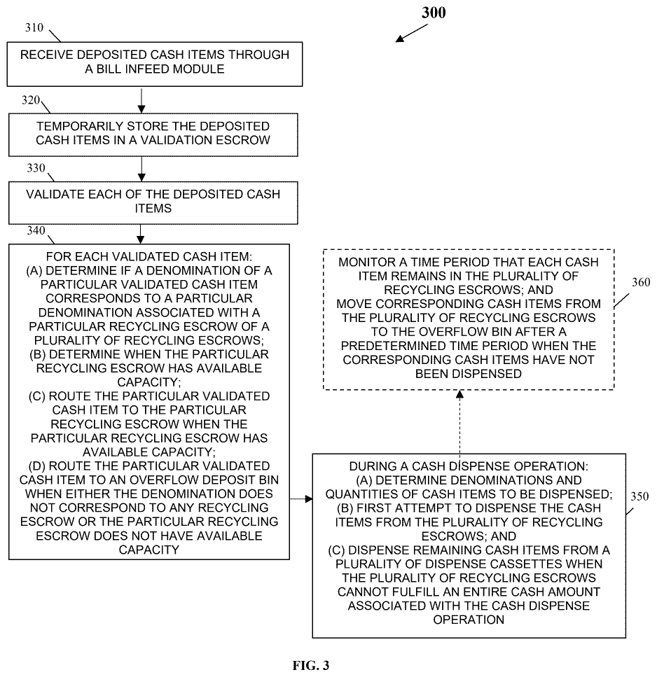

FIG. 3 is a diagram of a flow diagram of a method 300 for operating a hybrid dispense recycle module, according to an example embodiment. The software module(s) that implements the method 300 is referred to as “firmware.” The firmware is implemented as executable instructions programmed and residing within memory and/or a non-transitory computer-readable (processor-readable) storage medium and executed by one or more processors of one or more devices. The processor(s) of the device(s) that executes the firmware are specifically configured and programmed to process the firmware. The firmware may have access to one or more network connections during its processing. The network connections can be wired, wireless, or a combination of wired and wireless.

In an embodiment, the device that executes the firmware is hybrid dispense recycle module 100. In an embodiment, the firmware controls electromechanical modules or devices 110-170 for deposit transactions and withdraw transactions at terminal 200. The terminal 210 may be an ATM or an SST.

At 310, the firmware receives deposited cash items through a bill infeed module 110. At 320, the firmware temporarily stores the deposited cash items in a validation escrow 120. That is, after the cash items are processed through a bill validator module 114, they are temporarily stored in the validation escrow 120 until the validation determinations and corresponding flags for each cash item is received from the bill validation module 114.

At 330, each of the deposit cash items are validated. Again, the bill validator module 114 performs the validation and passes the determinations and corresponding flags that are associated with metadata to the firmware. The cash items are being temporarily stored in the validation escrow 120 until the firmware has the associated determinations and corresponding flags for each cash item as provided by the bill validator module 114.

At 340, the firmware for each validated cash item performs the following processing. At 340(A), the firmware determines if a denomination of a particular validated cash item corresponds to a particular denomination associated with a particular enhanced recycling escrow of a plurality of recycling escrows 121-124. At 340(B), the firmware determines when the particular recycling escrow has available capacity to accept a corresponding cash item.

At 340(C), the firmware routes the particular validated cash item to the particular recycling escrow when the particular recycling escrow has available capacity to store the particular validated cash item. At 340(D), the firmware routes the particular validated cash item to an overflow deposit bin 160 when either the denomination does not correspond to any recycling escrow 121-124 or the particular recycling escrow does not have available capacity.

At 350, the firmware during a dispense operation performs the following operations. At 350(A), the firmware determines denominations and quantities of cash items to be dispensed. At 350(B), the firmware first attempts to dispense the cash items from the plurality of recycling escrows 121-124. At 350(C), the firmware dispenses remaining cash items from a plurality of dispense cassettes 130-151 when the plurality of recycling escrows 121-124 cannot fulfill an entire cash amount associated with the cash dispense operation.

In an embodiment, at 360, the firmware monitors a time period that each cash item remains in the plurality of recycling escrows 121-124 and moves corresponding cash items from the plurality of recycling escrows 121-124 to the overflow bin 160 after a predetermined time period when the corresponding cash items have not been dispensed.

It should be appreciated that where software/firmware is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A hybrid dispense recycle module of a self-service terminal (SST) comprising:
dispense cassettes configured to store and dispense cash items;
recycling escrows positioned above the dispense cassettes, each recycling escrow configured to temporarily store deposited cash items of a specific denomination;
an overflow deposit bin configured to store certain deposited cash items that cannot be stored in the recycling escrows;
a validation escrow configured to temporarily hold the deposited cash items until each deposited cash item is validated; and
a transport path configured to route the cash items between the dispense cassettes, the recycling escrows, the overflow deposit bin, and the validation escrow.

2. The hybrid dispense recycle module of claim 1, wherein the dispense cassettes comprises three to four dispense cassettes, each having a capacity of approximately 2,500 notes.

3. The hybrid dispense recycle module of claim 1, wherein the recycling escrows comprises four recycling escrows, each having a capacity of approximately 200 notes.

4. The hybrid dispense recycle module of claim 1, wherein each of the recycling escrows is associated with a specific denomination of cash items based on usage patterns of cash at the SST.

5. The hybrid dispense recycle module of claim 4, wherein at least two of the recycling escrows are associated with a same denomination of cash items.

6. The hybrid dispense recycle module of claim 1, wherein the recycling escrows are configured to move the certain deposited cash items to the overflow deposit bin after a predetermined time period if the certain deposited cash items have not been dispensed.

7. The hybrid dispense recycle module of claim 1, wherein the transport path comprises an upper transport path for receiving particular deposited cash items and a lower transport path for routing the particular deposited cash items to and from the recycling escrows.

8. The hybrid dispense recycle module of claim 1, further comprising a printed circuit board (PCB) configured to maintain metrics of deposited and dispensed cash items, including denominations and positions within the recycling escrows and the dispense cassettes.

9. The hybrid dispense recycle module of claim 1, further comprising a deposit retract bin configured to store counterfeit cash items identified during validation.

10. The hybrid dispense recycle module of claim 1, further comprising a deposit divert path configured to return non-valid items to a customer.

11. The hybrid dispense recycle module of claim 1, further comprising a purge bin configured to store damaged cash items identified during validation.

12. A self-service terminal (SST), comprising:
a user interface;
a bill infeed module configured to receive cash items from a customer; and
a hybrid cash recycling module, comprising:
dispense cassettes configured to store and dispense cash items;
recycling escrows positioned above the dispense cassettes, each recycling escrow configured to temporarily store deposited cash items of a specific denomination;
an overflow deposit bin configured to store certain deposited cash items that cannot be stored in the recycling escrows;
a validation escrow configured to temporarily hold the deposited cash items until each deposited cash item is validated; and
a transport path configured to route the cash items between the dispense cassettes, the recycling escrows, the overflow deposit bin, and the validation escrow.

13. The SST of claim 12, wherein during a dispense operation, the hybrid cash recycling module is configured to first attempt to dispense requested cash items from the recycling escrows before dispensing from the dispense cassettes.

14. The SST of claim 12, wherein during a deposit operation, the hybrid cash recycling module is configured to route validated cash items to one of the recycling escrows when a denomination of a particular validated cash item corresponds to a particular denomination associated with a corresponding recycling escrow and the corresponding recycling escrow has available capacity.

15. The SST of claim 12, wherein during a deposit operation, the hybrid cash recycling module is configured to route validated cash items to the overflow deposit bin if either:
a denomination of a particular validated cash item does not correspond to any denomination associated with the recycling escrows; or
a particular recycling escrow associated with the denomination of the particular validated cash item is at full capacity.

16. The SST of claim 12, further comprising a bill validator module configured to validate each deposited cash item and identify counterfeit cash items or damaged cash items.

17. The SST of claim 12, wherein the dispense cassettes are arranged in a horizontal stack, and the recycling escrows are positioned above a topmost dispense cassette in the horizontal stack.

18. The SST of claim 12, wherein the SST is an automated teller machine (ATM), a kiosk, or a self-checkout terminal.

19. A method, comprising:
receiving deposited cash items through a bill infeed module;
temporarily storing the deposited cash items in a validation escrow;
validating each of the deposited cash items;
for each validated cash item:
determining when a denomination of a particular validated cash item corresponds to a particular denomination associated with a particular recycling escrow of a plurality of recycling escrows;
determining when the particular recycling escrow has available capacity;
routing the particular validated cash item to the particular recycling escrow when the particular recycling escrow has available capacity; and
routing the particular validated cash item to an overflow deposit bin when either the denomination does not correspond to any recycling escrow or the particular recycling escrow does not have available capacity;
during a cash dispense operation:
determining denominations and quantities of cash items to be dispensed;
first attempting to dispense the cash items from the plurality of recycling escrows; and
dispensing remaining cash items from a plurality of dispense cassettes when the plurality of recycling escrows cannot fulfill an entire cash amount for the cash dispense operation.

20. The method of claim 19, further comprising:
monitoring a time period that each cash item remains in the plurality of recycling escrows; and
moving corresponding cash items from the plurality of recycling escrows to the overflow deposit bin after a predetermined time period when the corresponding cash items have not been dispensed.
